(19) United States
(12) Patent Application Publication
(10) Pub. No.: US 2011/0047237 A1
(43) Pub. Date: Feb. 24, 2011

(54) PROXIMITY BASED MATCHMAKING USING COMMUNICATIONS DEVICES

(75) Inventors: Richard J. Walsh, Raleigh, NC (US); Alfredo C. Issa, Apex, NC (US)

Correspondence Address: WITHROW & TERRANOVA, P.L.L.C., 100 REGENCY FOREST DRIVE, SUITE 160, CARY, NC, 27518, US

(73) Assignee: OTO TECHNOLOGIES, LLC, Raleigh, NC (US)

(21) Appl. No.: 12/544,503

(22) Filed: Aug. 20, 2009

(51) Int. Cl. G06F 15/16; G06F 17/30

(52) U.S. Cl. 709/207; 709/227

(57) ABSTRACT

The present disclosure relates to a matchmaking system that can receive a matchmaking request from a first user who wishes to establish communications with a second user. The matchmaking request includes recognition information about the second user that is leveraged upon proximity of the first user to the second user. The matchmaking system attempts to identify the second user based on the recognition information. If the identification of the second user is successful, the matchmaking system sends data to the second user's communications device to establish communications. In one embodiment of the present disclosure, the recognition information includes biometric data of the second user. In an alternate embodiment of the present disclosure, the recognition information includes location information pertaining to a current location of the second user. In an additional embodiment of the present disclosure, the recognition information includes device information associated with the second user's communications device.

### FIELD OF THE INVENTION

Embodiments of the present disclosure relate to matchmaking systems that can communicate with communications devices of end users and facilitate establishment of communications between the end users.

### BACKGROUND OF THE INVENTION

Establishing communications between users of communications devices is commonplace and typically accomplished by a first user initiating communications with a second user using some identifying piece of information, such as an E-mail address, a phone number, or the like, which may by included in an address book of the first user. However, if the identifying piece of information is not readily available, such as not included in the address book of the first user, the first user must first obtain the identifying information and then enter it into the first user's communications device before communications can be established. Even if the first user is in proximity to the second user, some identifying piece of information about the second user must be entered into the first user's communications device. It may be useful if there was a way to take advantage of the proximity of the first user to the second user to readily provide the identifying piece of information. For example, if two coworkers with smart phones are at a conference, they may wish to link their smart phones to one another for content sharing purposes. However, if neither of the coworkers have one another in each other's respective address book, it may be inconvenient to establish communications due to crowded conditions, network connectivity issues in general, device discovery issues in particular, lack of privacy in sharing connectivity information, or the like. Therefore, quick, secure, and reliable ways to establish communications may be useful.

Alternatively, if the identity of the second user is unknown to the first user, or if the first user is not quite sure of the identity of the second user, the first user may wish to contact the second user through the second user's communications device without disturbing the second user. It would be useful if there was a way to take advantage of the proximity of the first user to the second user so that the first user could initiate communications with the second user.

### SUMMARY OF THE EMBODIMENTS

The present disclosure relates to a matchmaking system that can receive a matchmaking request from a first user who wishes to establish communications with a second user. The matchmaking request includes recognition information about the second user that is leveraged upon proximity of the first user to the second user. The matchmaking system attempts to identify the second user based on the recognition information. If the identification of the second user is successful, and if the second user allows establishment of such communications, the matchmaking system sends first data to the second user's communications device to establish communications. In one embodiment of the present disclosure, the recognition information includes biometric data of the second user recorded by the first user's communications device. In an alternate embodiment of the present disclosure, the recognition information includes location information pertaining to a current location of the second user. In an additional embodiment of the present disclosure, the recognition information includes locally obtained device information associated with the second user's communications device.

In one embodiment of the present disclosure, if the identification of the second user is unsuccessful, interactive matchmaking may be used. In interactive matchmaking, which may be iterative, supplemental recognition information about the second user may be provided by the first user to aid in identification of the second user. If the identification of the second user is successful, matchmaking rules and options associated with the first user, the second user, or both, may be used to further determine if the matchmaking request is successful. If the matchmaking request is successful, communications options may be used to determine the first data, which is then sent to establish communications. Once communications are established, the communications between the first user and the second user may be limited to the first data, may include a single reply message from the second user to the first user, may include multiple messages between the first and the second users, may involve a content sharing session between the first and the second users, or the like.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 shows a matchmaking system, a first communications device associated with a first user, a second communications device associated with a second user, and a first communications network according to one embodiment of the present disclosure.

FIG. 2 shows the matchmaking system, the first communications device associated with the first user, the second communications device associated with the second user, the first communications network, and a second communications network according to an alternate embodiment of the present disclosure.

FIG. 3 shows the matchmaking system, the first communications device associated with the first user, the second communications device associated with the second user, the first communications network, and the second communications network according to an additional embodiment of the present disclosure.

FIG. 4 shows the matchmaking system, the first communications device associated with the first user, the second communications device associated with the second user, the first communications network, the second communications network, and a third communications network according to another embodiment of the present disclosure.

FIG. 5 shows details of the matchmaking system illustrated in FIGS. 1 through 4 according to one embodiment of the matchmaking system.

FIG. 6 shows the first user holding the first communications device and the second user holding the second communications device according to an exemplary embodiment of the present disclosure.

FIG. 7 shows details of a recognition information database illustrated in FIG. 5 according to one embodiment of the recognition information database.

FIG. 8 illustrates a method used by the matchmaking system to receive and process a matchmaking request, and attempt to establish communications if the matchmaking request is successful according to one embodiment of the present disclosure

FIG. 9 shows details of a processing a matchmaking request method step illustrated in FIG. 8 according to one embodiment of the processing the matchmaking request method step.

FIG. 10 shows details of an if the identification of the second user is successful method step illustrated in FIG. 8 according to one embodiment of the if the identification of the second user is successful method step.

### DETAILED DESCRIPTION OF THE PREFERRED EMBODIMENTS

The embodiments set forth below represent the necessary information to enable those skilled in the art to practice the disclosure and illustrate the best mode of practicing the disclosure. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

The present disclosure relates to a matchmaking system that can receive a matchmaking request from a first user who wishes to establish communications with a second user. The matchmaking request includes recognition information about the second user that is leveraged upon proximity of the first user to the second user. The matchmaking system attempts to identify the second user based on the recognition information. If the identification of the second user is successful and if the second user allows establishment of such communications, the matchmaking system sends first data to the second user's communications device to establish communications. In one embodiment of the present disclosure, the recognition information includes biometric data of the second user recorded by the first user's communications device. In an alternate embodiment of the present disclosure, the recognition information includes location information pertaining to a current location of the second user. In an additional embodiment of the present disclosure, the recognition information includes locally obtained device information associated with the second user's communications device.

In one embodiment of the present disclosure, if the identification of the second user is unsuccessful, interactive matchmaking may be used. In interactive matchmaking, which may be iterative, supplemental recognition information about the second user may be provided by the first user to aid in the identification of the second user. If the identification of the second user is successful, matchmaking rules and options associated with the first user, the second user, or both may be used to further determine if the matchmaking request is successful. If the matchmaking request is successful, communications options may be used to determine the first data, which is then sent to establish communications. Once communications are established, the communications between the first user and the second user may be limited to the first data, may include a single reply message from the second user to the first user, may include multiple messages between the first and the second users, may involve a content sharing session between the first and the second users, or the like.

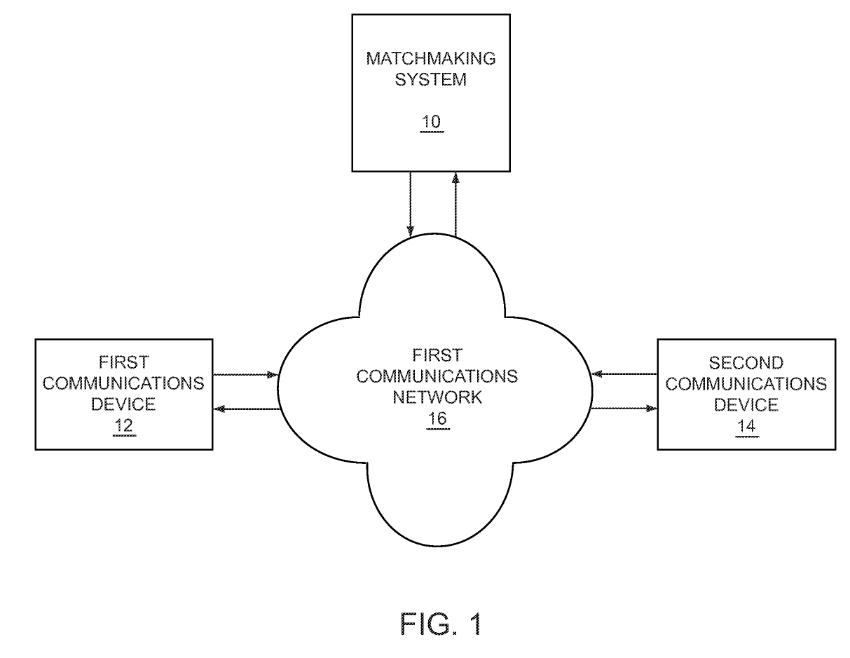

FIG. 1 shows a matchmaking system 10, a first communications device 12 associated with a first user (not shown), a second communications device 14 associated with a second user (not shown), and a first communications network 16 according to one embodiment of the present disclosure. The matchmaking system 10 receives a matchmaking request and recognition information from the first communications device 12 using the first communications network 16. If the matchmaking request is successful, the matchmaking system 10 sends first data to the second communications device 14 using the first communications network 16 to establish communications between the first user and the second user. The first data may be any type of data needed to establish communications between the first user and the second user, such as a request to the second user to establish communications, data the first user wishes to send to the second user, device information about the first communications device 12, user profile information about the first user, contextual information about the first user, such as location or sensor data, content metadata about data the first user wishes to share with the second user, such as content type, content size, or content source, content sharing metadata related to the data the first user wishes to share with the second user, such as time frame options, content format options, such as resolution or file formats, connectivity options, such as types of protocols available, or the like. Once communications are established, information may be transferred from the first communications device 12 to the second communications device 14, from the second communications device 14 to the first communications device 12, or both using the first communications network 16. The information transfer may be directly between the first and the second communications devices 12, 14, may be relayed through the matchmaking system 10, or both.

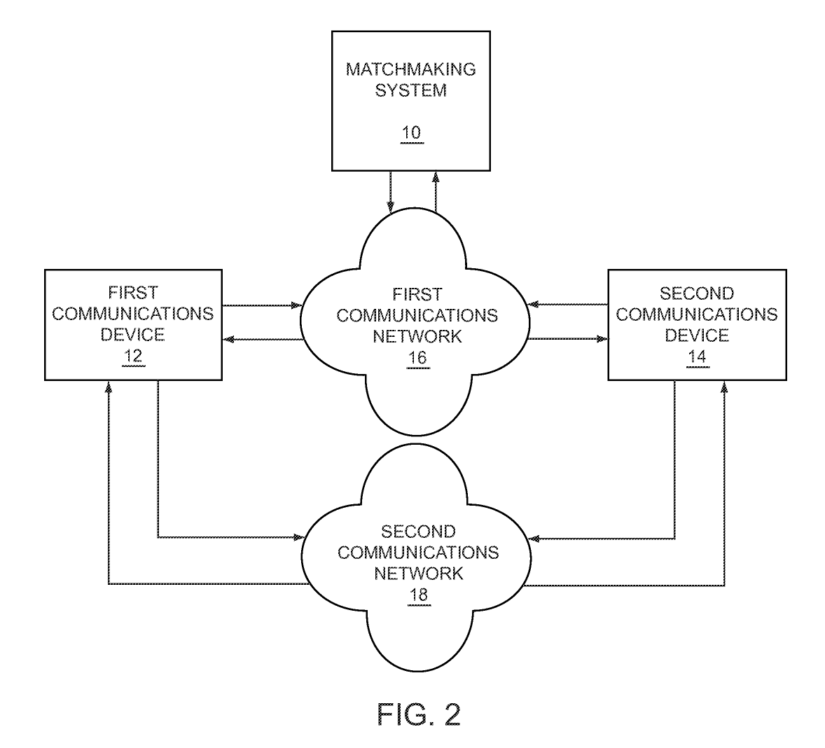

FIG. 2 shows the matchmaking system 10, the first communications device 12 associated with the first user, the second communications device 14 associated with the second user, the first communications network 16, and a second communications network 18 according to an alternate embodiment of the present disclosure. The matchmaking system 10 receives a matchmaking request and recognition information from the first communications device 12 using the first communications network 16. If the matchmaking request is successful, the matchmaking system 10 sends the first data to the second communications device 14 using the first communications network 16 to establish communications between the first user and the second user (not shown). Once communications are established, information may be transferred from the first communications device 12 to the second communications device 14, from the second communications device 14 to the first communications device 12, or both, using the first communications network 16, the second communications network 18, or both. The information transfer may be directly between the first and the second communications devices 12, 14 using the first communications network 16, the second communications network 18, or both, may be relayed through the matchmaking system 10 using the first communications network 16, or both. The first and the second communications networks 16, 18 may overlap one another.

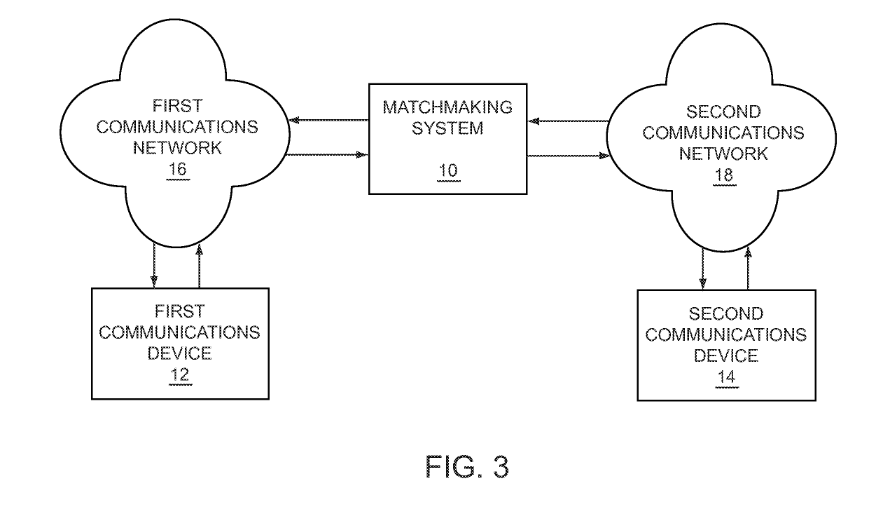

FIG. 3 shows the matchmaking system 10, the first communications device 12 associated with the first user, the second communications device 14 associated with the second user, the first communications network 16, and the second communications network 18 according to an additional embodiment of the present disclosure. The matchmaking system 10 receives a matchmaking request and recognition information from the first communications device 12 using the first communications network 16. If the matchmaking request is successful, the matchmaking system 10 sends first data to the second communications device 14 using the second communications network 18 to establish communications between the first user and the second user (not shown). Once communications are established, information may be transferred from the first communications device 12 to the second communications device 14, from the second communications device 14 to the first communications device 12, or both, using the first and the second communications networks 16, 18. The information transfer may be directly between the first and the second communications devices 12, 14, may be relayed through the matchmaking system 10, or both. The first and the second communications networks 16, 18 may overlap one another.

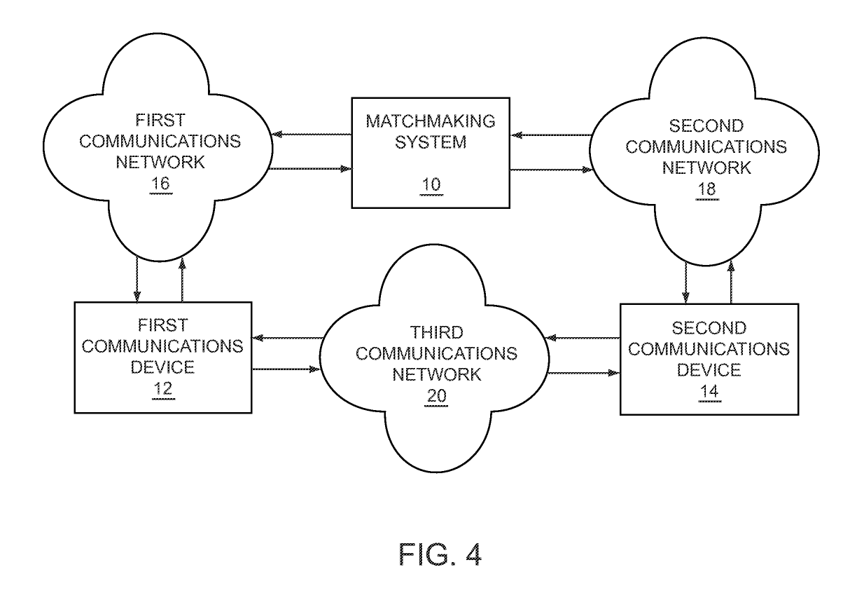

FIG. 4 shows the matchmaking system 10, the first communications device 12 associated with the first user, the second communications device 14 associated with the second user, the first communications network 16, the second communications network 18, and a third communications network 20 according to another embodiment of the present disclosure. The matchmaking system 10 receives a matchmaking request and recognition information from the first communications device 12 using the first communications network 16. If the matchmaking request is successful, the matchmaking system 10 sends first data to the second communications device 14 using the second communications network 18 to establish communications between the first user and the second user(not shown). Once communications are established, information may be transferred from the first communications device 12 to the second communications device 14, from the second communications device 14 to the first communications device 12, or both, using the first communications network 16, the second communications network 18, the third communications network 20, or any combination thereof. The information transfer may be directly between the first and the second communications devices 12, 14 using the first communications network 16, the second communications network 18, the third communications network 20, or any combination thereof may be relayed through the matchmaking system 10 using the first and the second communications networks 16, 18, or both. The first, the second, and the third communications networks 16, 18, 20 may overlap one another.

Each of the first communications network 16, the second communications network 18, and the third communications network 20 may include any or all of one or more local area network (LAN), one or more wireless LAN (WLAN), such as wireless fidelity (WIFI) or Bluetooth™, one or more wireless access point, one or more telephone land line, one or more digital subscriber line (DSL), one or more cellular network, one or more internet edge network, one or more internet enterprise network, one or more internet aggregation network, one or more internet core network, the like, or any combination thereof.

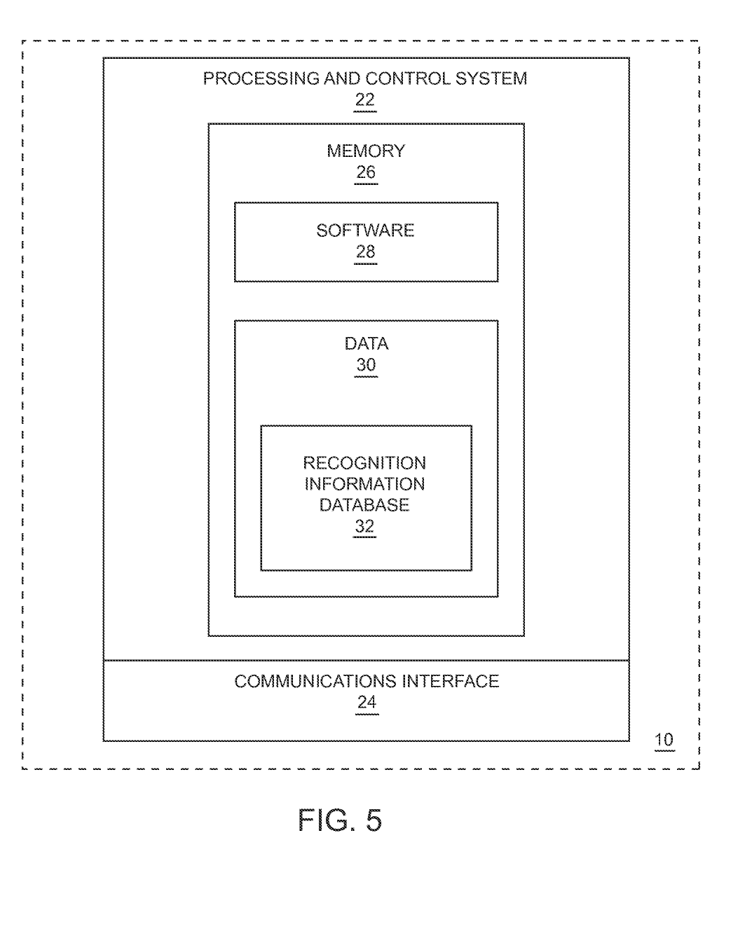

FIG. 5 shows details of the matchmaking system 10 illustrated in FIGS. 1 through 4 according to one embodiment of the matchmaking system 10. The matchmaking system 10 includes a processing and control system 22 and a communications interface 24. The communications interface 24 may provide an interface to the first communications network 16, the second communications network 18, or both. The processing and control system 22 includes memory 26, which may include software 28, such as an operating system, interface drivers, application software, or the like, and data 30, which may include a recognition information database 32. The memory 26 may include volatile memory, such as random access memory (RAM), and non-volatile memory, such as battery-backed RAM, read only memory (ROM), programmable ROM (PROM), erasable PROM (EPROM), electrically-erasable PROM (EEPROM), flash memory, magnetic storage memory, one or more hard drives, one or more compact disk (CD) drive accessing one or more CD, one or more digital versatile disk (DVD) drive accessing one or more DVD, the like, other memory technology, or any combination thereof.

The recognition information database 32 contains recognition information records (not shown) of users that are used for comparison purposes to identify users based on recognition information provided to the matchmaking system 10. The recognition information database 32 may not store all of the recognition information all of the time. In one embodiment of the matchmaking system 10, the matchmaking system 10 retrieves recognition information from a recognition library or a social networking database as needed. The data 30 may further include a communications database (not shown), which may be used to store information regarding communications devices and communications options that are associated with each user, and a matchmaking rules and options database (not shown) to store matchmaking rules and options for each user.

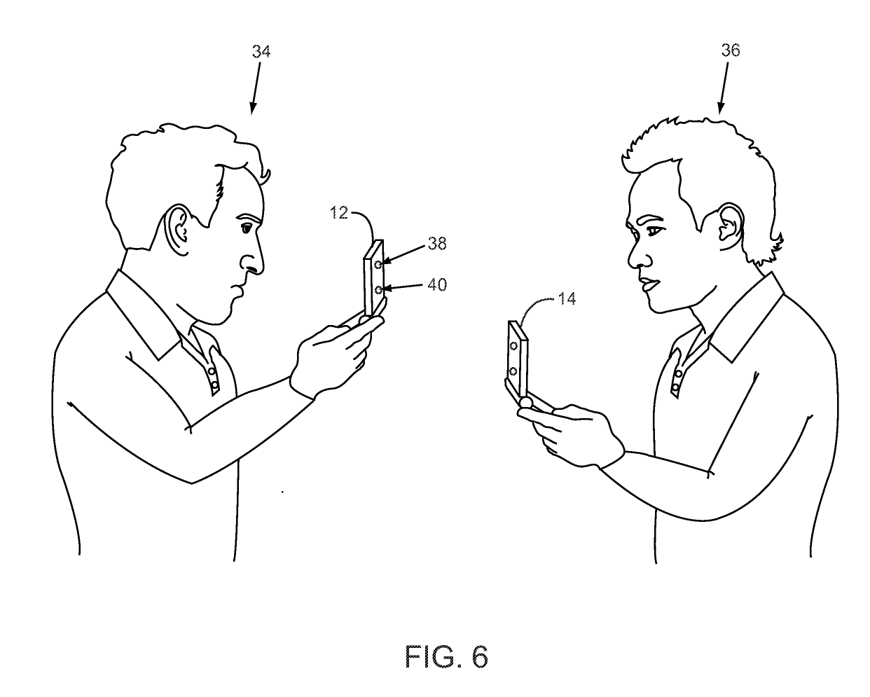

FIG. 6 shows a first user 34 holding the first communications device 12 and a second user 36 holding the second communications device 14 according to an exemplary embodiment of the present disclosure. The first and the second communications devices 12, 14 may be cell phones, such as smart phones. Examples of a smart phone may include an iPhone™ or a Blackberry™. The first communications device 12 may include an optical sensor 38, a microphone 40, a first global positioning system (GPS) receiver (not shown), the like, or any combination thereof. The second communications device 14 may include a second GPS receiver (not shown).

In the exemplary embodiment of the present disclosure, the first user 34 wishes to establish communications with the second user 36. The identity of the second user 36 may or may not be recognized by the first user 34. The first user 34 may or may not be conversing with the second user 36. The second user 36 may or may not be assisting the first user 34 in establishing communications. The first user 34 obtains recognition information regarding the second user 36 using the first communications device 12.

In one embodiment of the recognition information, the recognition information includes biometric data regarding the second user 36. The first user 34 may use the first communications device 12 to record the biometric data of the second user 36. In a first exemplary embodiment of the biometric data, the biometric data may include facial details of the second user 36 by taking an optical image, such as a picture, or a video image of the face of the second user 36 using the optical sensor 38 in the first communications device 12. In a second exemplary embodiment of the biometric data, the biometric data may include vocal characteristics of the second user 36 by making an audio recording of the voice of the second user 36 using the microphone 40 in the first communications device 12. In a third exemplary embodiment of the biometric data, the biometric data may include fingerprint details of the second user 36 by taking an optical image of a fingerprint of the second user 36 using the optical sensor 38 in the first communications device 12. In a fourth exemplary embodiment of the biometric data, the biometric data may include retina details of the second user 36 by making a retinal scan of an eye of the second user 36 using the optical sensor 38 in the first communications device 12. The recognition information may include a combination of any or all of the biometric data obtained in the first, the second, the third, and the fourth exemplary embodiments presented above.

In an alternate embodiment of the recognition information, the recognition information includes location information pertaining to a current location of the second user 36. In a first embodiment of the location information, the location information is based on information obtained from the first GPS receiver. In a second embodiment of the location information, the location information is based on information obtained from the second GPS receiver. The recognition information may include a combination of the location information and a combination of any or all of the biometric data obtained in the first, the second, the third, and the fourth exemplary embodiments presented above. The matchmaking system 10 may use the location information to identify a subset of users having a communications device within a search range of a location associated with the location information. The matchmaking system 10 may then attempt to identify the user using biometric information associated with the subset of users. If the identification is unsuccessful, the search range may be expanded.

In an additional embodiment of the recognition information, the recognition information includes locally obtained device information associated with the second communications device 14. The locally obtained device information may include a network device ID, such as a media access controller (MAC) address or a Bluetooth™ device address (BD_ADDR), associated with the second communications device 14. The locally obtained device information associated with the second communications device 14 may be obtained by the first communications device 12. For example, both the first and the second communications devices 12, 14 may have Bluetooth™ interfaces, which are both enabled. As such, the BD_ADDR associated with the Bluetooth™ interface of the second communications device 14 may be available to the first communications device 12. The recognition information may include a combination of the locally obtained device information and the location information. Alternatively, the recognition information may include a combination of the locally obtained device information and a combination of any or all of the biometric data obtained in the first, the second, the third, and the fourth exemplary embodiments presented above. Further, the recognition information may include a combination of the locally obtained device information, the location information, and a combination of any or all of the biometric data obtained in the first, the second, the third, and the fourth exemplary embodiments presented above. The first communications device 12 may process the biometric data before sending the matchmaking request, such that the recognition information may include the biometric data, processed biometric data, the locally obtained device information, the location information, or any combination thereof. For example, an image may be analyzed using an image analysis program, such that the processed biometric data includes analyzed image data. Further, data associated with the image may be compressed, re-formatted, or both.

In another embodiment of the recognition information, the recognition information includes any or all of the recognition information presented above combined with additional identifying information associated with the second user 36. The additional identifying information may be entered into the first communications device 12 by the first user 34 or another, and may include the second user's 36 first name, nickname, middle name, last name, descriptive information about the second user, such as hair color, eye color, height, weight, or the like, personal information about the second user, such as social security number, employee number, matchmaking ID number, mother's maiden name, a sketch of the face of the second user 36, which may be developed using facial sketching software, or any combination thereof. Additionally, the additional identifying information may be associated with the second communications device 14. For example, the first user 34 may notice that the second communications device 14 is an iPhone™. The additional identifying information may indicate that the second communications device 14 is an iPhone™, such that the matchmaking system 10 can exclude users without iPhones™ in its matchmaking search.

The first user 34 may use the first communications device 12 to send a matchmaking request and the recognition information to the matchmaking system 10, which then attempts to identify the second user 36 based on the recognition information. In one embodiment of the present disclosure, the matchmaking system 10 may assume the identification is made if the probability of success is equal to or greater than a given threshold. If the probability of success is less than the given threshold, the matchmaking system may report an unsuccessful identification to the first communications device 12, may send a request to the first communications device 12 for supplemental recognition information about the second user 36, or may report the probability of success to the first communications device 12 with a request for further instructions. In an alternate embodiment of the present disclosure, the matchmaking system 10 always reports the probability of a successful identification to the first communications device 12 with a request for further instructions.

If identification of the second user 36 is unsuccessful, interactive matchmaking may be used to help identify the second user 36. In interactive matchmaking, which may be iterative, the matchmaking system 10 receives supplemental recognition information, which is associated with the second user 36, from the first communications device 12.

In one embodiment of the supplemental recognition information, the supplemental recognition information includes the biometric data regarding the second user 36. The supplemental recognition information may include any or all of the biometric data obtained in the first the second, the third, and the fourth exemplary embodiments presented above.

In an alternate embodiment of the supplemental recognition information, the supplemental recognition information includes location information pertaining to a current location of the second user 36. In a first embodiment of the location information, the location information is based on information obtained from the first GPS receiver. In a second embodiment of the location information, the location information is based on information obtained from the second GPS receiver. The supplemental recognition information may include a combination of the location information and a combination of any or all of the biometric data obtained in the first the second, the third, and the fourth exemplary embodiments presented above.

In an additional embodiment of the supplemental recognition information, the supplemental recognition information includes locally obtained device information associated with the second communications device 14. The locally obtained device information may include a network device ID associated with the second communications device 14. The locally obtained device information associated with the second communications device 14 may be obtained by the first communications device 12. For example, both the first and the second communications devices 12, 14 may have Bluetooth™ interfaces, which are both enabled. As such, the BD_ADDR associated with the Bluetooth™ interface of the second communications device 14 may be available to the first communications device 12. The supplemental recognition information may include a combination of the locally obtained device information and the location information. Alternatively, the supplemental recognition information may include a combination of the locally obtained device information and a combination of any or all of the biometric data obtained in the first, the second, the third, and the fourth exemplary embodiments presented above. Further, the supplemental recognition information may include a combination of the locally obtained device information, the location information, and a combination of any or all of the biometric data obtained in the first, the second, the third, and the fourth exemplary embodiments presented above.

In another embodiment of the supplemental recognition information, the supplemental recognition information includes any or all of the supplemental recognition information presented above combined with additional identifying information associated with the second user 36. The additional identifying information may be entered into the first communications device 12 by the first user 34 or another, and may include the second user's 36 first name, nickname, middle name, last name, descriptive information about the second user, such as hair color, eye color, height, weight, or the like, personal information about the second user, such as social security number, employee number, matchmaking ID number, mother's maiden name, a sketch of the face of the second user 36, which may be developed using facial sketching software, or any combination thereof.

The interactive matchmaking may be iterative with the first user 34 using the first communications device 12 to provide successive pieces of supplemental recognition information to the matchmaking system 10 to successively increase the probability of success. Once the second user 36 has been successively identified, the matchmaking system 10 proceeds to determine if the matchmaking request is successful or not.

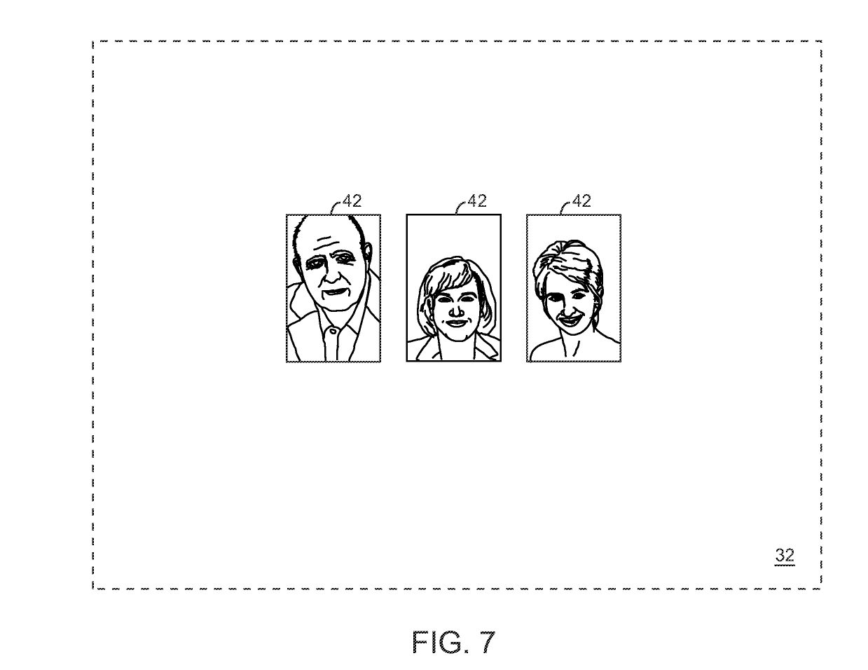

FIG. 7 shows details of the recognition information database 32 illustrated in FIG. 5 according to one embodiment of the recognition information database 32. The recognition information database 32 may include digital representations of facial images 42, such that each facial image 42 is associated with a user of the matchmaking system 10, and the digital representations of the facial images 42 are used to compare with recognition information associated with matchmaking requests.

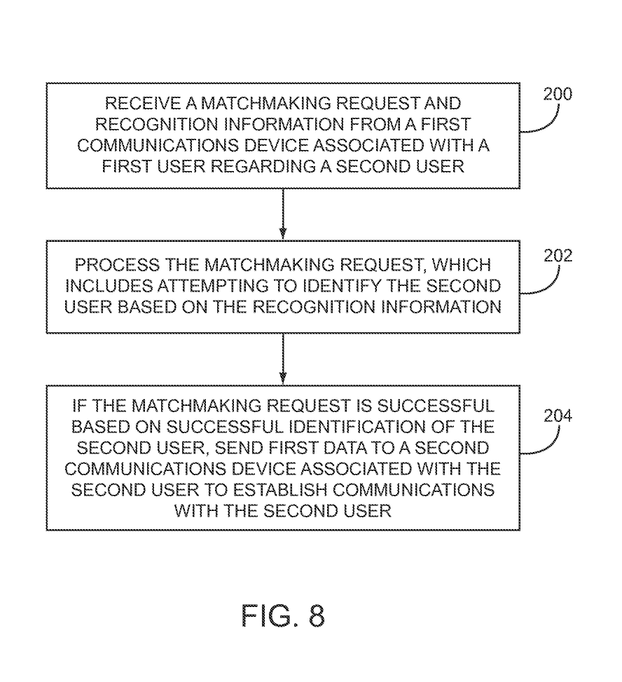

FIG. 8 illustrates a method used by the matchmaking system 10 to receive and process a matchmaking request, and attempt to establish communications if the matchmaking request is successful according to one embodiment of the present disclosure. The matchmaking system 10 receives a matchmaking request and recognition information from the first communications device 12 associated with the first user 34 (FIG. 6) regarding the second user 36 (FIG. 6)(Step 200). The matchmaking system 10 processes the matchmaking request which includes attempting to identify the second user 36 (FIG. 6) based on the recognition information (Step 202). If the matchmaking request is successful based on successful identification of the second user 36, the matchmaking system 10 sends first data to the second communications device 14 associated with the second user 36 to establish communications with the second user 36 (Step 204). In one embodiment of the method step (Step 202) associated with attempting to identify the second user, the attempt to identify the second user 36 is further based on facial recognition. In an alternate embodiment of the method step (Step 202) associated with attempting to identify the second user, the attempt to identify the second user 36 is further based on voice recognition. In an additional embodiment of the method step (Step 202) associated with attempting to identify the second user, the attempt to identify the second user 36 is further based on fingerprint identification. In another embodiment of the method step (Step 202) associated with attempting to identify the second user, the attempt to identify the second user 36 is further based on executing a recognition algorithm using the recognition information.

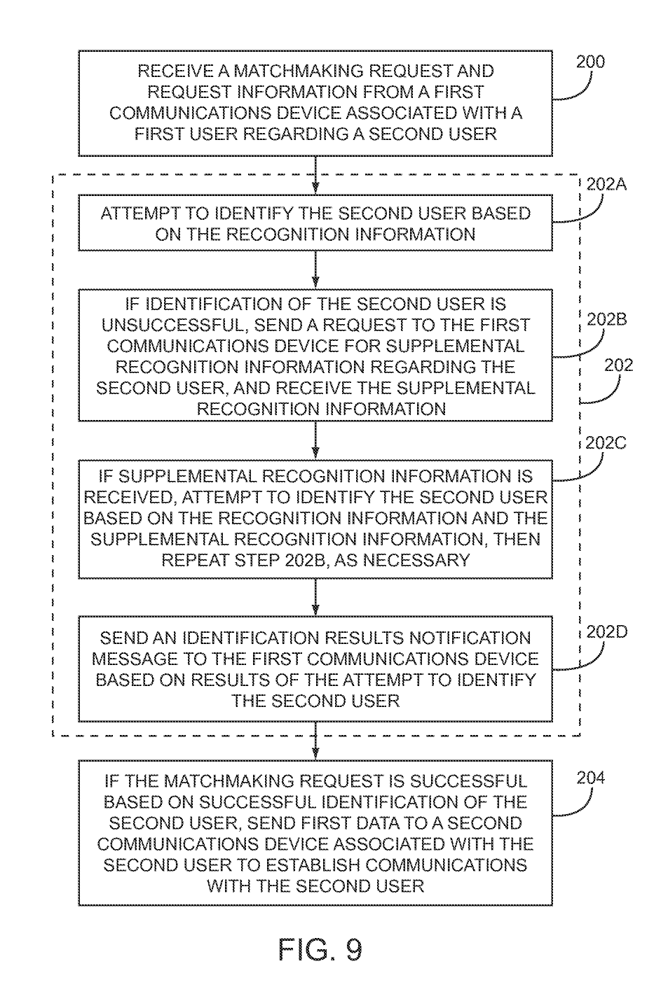

FIG. 9 shows details of the processing the matchmaking request method step (Step 202) illustrated in FIG. 8 according to one embodiment of the processing the matchmaking request method step (Step 202). The matchmaking system 10 attempts to identify the second user 36 (FIG. 6) based on the recognition information (Step 202A). If identification of the second user 36 is unsuccessful, the matchmaking system 10 sends a request to the first communications device 12 for supplemental recognition information regarding the second user 36, and receives the supplemental recognition information (Step 202B) from the first communications device 12. If the matchmaking system 10 receives the supplemental recognition information, the matchmaking system 10 attempts to identify the second user 36 (FIG. 6) based on the recognition information and the supplemental recognition information, then step 202B is repeated, as necessary (Step 202C). The matchmaking system 10 sends an identification results notification message to the first communications device 12 based on the results of the attempt to identify the second user 36 (Step 202D). Examples of the results include the identification of the second user 36 was successful, the identification of the second user 36 was unsuccessful, the identification of the second user 36 was successful within a certain probability of success, or the like.

In one embodiment of the processing the matchmaking request method step (Step 202)(FIG. 8), the matchmaking system 10 may assume the identification is made if the probability of success is equal to or greater than a given threshold. If the probability of success is less than the given threshold, the matchmaking system 10 may proceed directly to the method step (Step 202D) associated with sending the identification results notification message, the matchmaking system 10 may proceed to the next method step (Step 202B), or the matchmaking system 10 may send a request to the first communications device 12 for further instructions. In one embodiment of the processing the matchmaking request method step (Step 202)(FIG. 8), the matchmaking system 10 always reports the probability of a successful identification to the first communications device 12 with a request for further instructions. In an alternate embodiment of the method step (Step 202) associated with processing the matchmaking request, the method step (Step 202D) associated with sending an identification results notification message is omitted. In an additional embodiment of the method step (Step 202) associated with processing the matchmaking request, the method step (Step 202B) associated with sending a request to the first communications device 12 for supplemental recognition information and the method step (Step 202C) associated with repeating step 202B are omitted.

In one embodiment of the method step (Step 202B) associated with sending a request for supplemental recognition information, the second user 36 may have previously configured the matchmaking system 10 to use specific recognition information in the recognition information database 32 (FIG. 5). For example, the second user 36 may have configured the matchmaking system 10 to select between using an original image, allowing context metadata to select an image, using a distorted image, using a caricature, using specific facial element representations, the like, or any combination thereof. The context metadata may specify different contexts of the second user 36. For example, the recognition information database 32 may include multiple digital representations of facial images 42, of the second user 36 in different contextual situations, such as in a baseball uniform, with make-up applied, without make-up applied, or the like. Each facial image 42 may be related to one or more contextual situations, for example, when the second user 36 is at the ballpark, the matchmaking system 10 may use the facial image 42 of the second user 36 in the baseball uniform, when the second user 36 is at the gym or the swimming pool, the matchmaking system 10 may use the facial image 42 of the second user 36 without make-up applied, otherwise in all other contexts the matchmaking system 10 uses the facial image 42 of the second user 36 with make-up applied. The first communication device 12 sends the recognition information or the supplemental recognition information including the context metadata to the matchmaking system 10, which uses the context metadata to determine the contextual situation and then select the appropriate facial image 42. In this example, the context metadata may specify that the second user 36 is at a ballpark, at a swimming pool, at a gym, or the like.

The specific facial element representations may be a graphical representation or a datafile created using facial sketching software, which allows a user to create a sketch that is representative of the face of the second user 36. Such software may be similar to that used by law enforcement agencies to create police sketches of suspects.

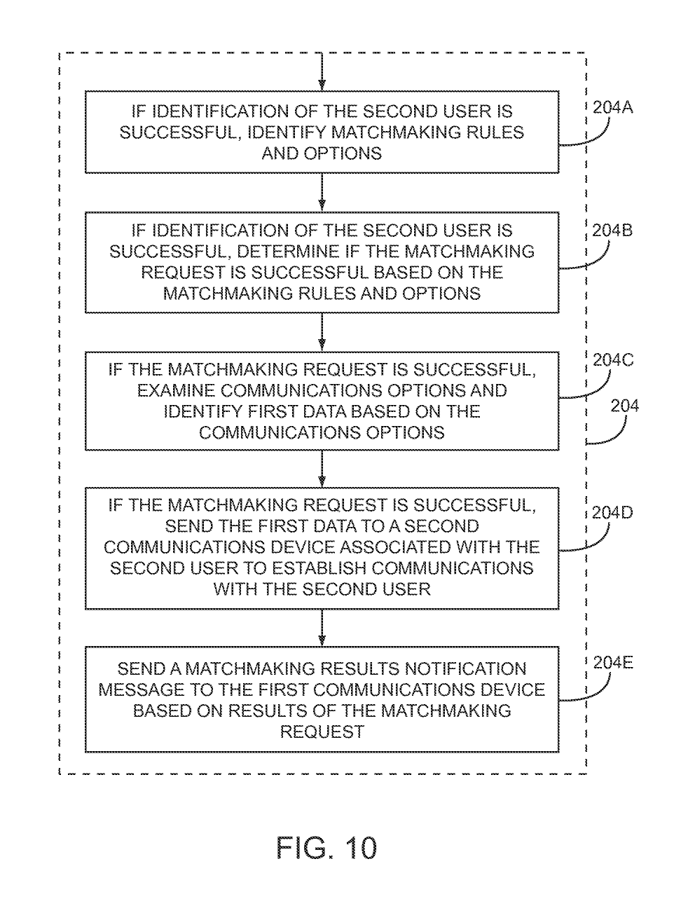

FIG. 10 shows details of the method step (Step 204) associated with if the matchmaking request is successful illustrated in FIG. 8 according to one embodiment of the method step (Step 204) associated with if the matchmaking request is successful. If the identification of the second user 36 (FIG. 6) is successful, the matchmaking system 10 identifies matchmaking rules and options (Step 204A). If the identification of the second user 36 is successful, the matchmaking system 10 determines if the matchmaking request is successful based on the matchmaking rules and options (Step 204B). If the matchmaking request is successful, the matchmaking system 10 examines communications options and identifies the first data based on the communications options (Step 204C). If the matchmaking request is successful, the matchmaking system 10 sends the first data to the second communications device 14, which is associated with the second user 36, to establish communications with the second user 36 (Step 204D). The matchmaking system 10 sends a matchmaking results notification message to the first communications device 12 based on results of the matchmaking request (Step 204E).

In an alternate embodiment of the method step (Step 204) associated with if the matchmaking request is successful, the method step (Step 204E) associated with sending a matchmaking results notification message is omitted. In an additional embodiment of the method step (Step 204) associated with if the matchmaking request is successful, the method step (Step 204C) associated with examining communications options is omitted. In another embodiment of the method step (Step 204) associated with if the matchmaking request is successful, the method step (Step 204A) associated with the matchmaking system identifying matchmaking rules and options and the method step (Step 204B) associated with the matchmaking system determining if the matchmaking request is successful based on the matchmaking rules and options are both omitted.

The matchmaking rules and options associated with the method step (Step 204A) associated with the matchmaking system identifying matchmaking rules and options and the method step (Step 204B) associated with the matchmaking system determining if the matchmaking request is successful based on the matchmaking rules and options may be based on matchmaking information, which may be included in the matchmaking requests in a response to a request for supplemental recognition information, in the matchmaking rules and options database of the data 30 (FIG. 5), or any combination thereof. The matchmaking information may be associated with the first user 34, the second user 36, or both.

One matchmaking option allows the second user 36 to receive or view information regarding the first user 34 before deciding whether to accept the matchmaking request or not. The matchmaking option allows the first user 34 to decide which information may be shared. Such information may include an image of the first user 34, the first user's 34 personal profile, such as name, employer, school, the first user's 34 social network information, or the like. Similarly, the second user 36 may establish matchmaking rules to automatically accept the matchmaking request or not based on information in the first user's 34 personal profile, the first user's 34 social network information, or the like.

Since recognition searching may be very processor intensive, the matchmaking information may direct the matchmaking system 10 to limit recognition searches to specific subsets of the recognition information database 32 (FIG. 5). The matchmaking system 10 may identify the subsets based on social network, device information, contextual information, or the like. For example, the first user 34 may direct the matchmaking system 10 to identify a subset containing only those persons within the same social network as the first user 34. Conversely, the first user 34 may direct the matchmaking system 10 to identify a subset containing only those persons outside of the same social network as the first user 34. The first user 34 may direct the matchmaking system 10 to identify a subset containing only those persons with a similar profile match as the first user 34. For example, the first user 34 may direct the matchmaking system 10 to identify a subset containing only those persons who live within 20 miles of the first user 34 who play backgammon. The first user 34 may obtain specific information about the second communications device 14, such as make, model, network device ID, such as a MAC address or a BD_ADDR, wireless carrier, or the like, and may then enter the specific information into the first communications device 12. Alternatively, the first user 34 may use the first communications device 12 to obtain the specific information about the second communications device 14. Then, the first user 34 may direct the matchmaking system 10 to identify a subset containing only those persons having devices that meet the specified criteria. Further, the first user 34 may direct the matchmaking system 10 to identify a subset containing only those persons meeting certain contextual criteria. For example, if the second user 36 is within five feet of the first user 34 and the second communications device 14 is active, the first user 34 may direct the matchmaking system 10 to determine the location of the first communications device 12 using a GPS receiver in the first communications device 12, and then identify a subset containing only those persons having devices that are currently active and within five feet of the location of the first communications device 12.

Any of the criteria used in the preceding paragraph for creating subsets may instead be used after a recognition search has been successfully completed as matchmaking information to determine if a matchmaking request is successful or not.

The first user 34, the second user 36, or both, may establish a matchmaking rule that restricts matchmaking based on location criteria, time criteria, or both. For example, the second user 36 may prohibit matchmaking between 9:00 AM and 10:00 AM on Mondays, which is when her boss has a weekly staff meeting or the second user 36 may prohibit matchmaking when they are in New York City. The location criteria may be based on location metadata, which may reference a location database in the matchmaking system 10. The location database may relate the location metadata to actual locations of specific items. For example, the second user 36 only allows matchmaking when in or near a “school”, a “park”, a “mall”, or “a place with trees.” The “school”, the “park”, the “mall”, and “the place with trees” are examples of location metadata. The location database may relate all of the schools in a region with the locations of the schools, all of the malls in a region with the locations of the malls, and so on. The matchmaking system 10 then uses the location metadata and the location database to determine those locations where matchmaking is allowed.

The first user 34, the second user 36, or both, may establish a matchmaking rule that restricts matchmaking based on social network criteria. For example, the first user 34 only allows matchmaking when the second user 36 is in the same social network with up to three degrees of separation. The social network criteria may include social network profile affinity. For example, the second user 36 only allows matchmaking when the first user 34 is female, plays World of Warcraft™, and likes heavy metal music.

The first user 34, the second user 36, or both, may establish a matchmaking rule that restricts matchmaking based on third party verification. For example, the matchmaking rule may direct the matchmaking system 10 to access a criminal records database or a credit bureau and prohibit matchmaking if a user has a criminal record or a credit score below 600.

The first user 34, the second user 36, or both, may establish a matchmaking rule that restricts matchmaking based on device context. For example, the second user 36 may prohibit matchmaking when the second communications device 14 is in use and their child's Nintendo DS™ is in range of the second communications device 14.

The first user 34, the second user 36, or both, may establish a matchmaking rule that is based on a combination of matchmaking rules. For example, the second user 36 may prohibit matchmaking when the second communications device 14 is in use and their child's Nintendo DS™ is in range of the second communications device 14, and the first user 34 is a non-business person in their social network.

A third party, such as a parent may be able to establish matchmaking rules for their children. For example, if the second user 36 is a minor, their parent may establish a matchmaking rule that directs the matchmaking system 10 to send all matchmaking requests to a communications device associated with the parent for approval before matchmaking may proceed.

The communications options associated with the method step (Step 204C) associated with the matchmaking system 10 examining communications options and identifying the first data may be based on communications options information, which may be included in the matchmaking request, in the communications database of the data 30 (FIG. 5), or both. The communications options information may include device information associated with the first communications device 12, the second communications device 14, or both, such as type of device, internet protocol (IP) address, network device ID, such as a MAC address or a BD_ADDR, the like, or any combination thereof. The communications options information may include user profile information about the first user 34, the second user 36, or both, such as personal preferences, hobbies, social network information, the like, or any combination thereof. The communications options information may include contextual information, such as present location of the first communications device 12, the second communications device 14, or both, active sensors or devices in the first communications device 12, the second communications device 14, or both, or any combination thereof.

The communications options information may include content metadata associated with the first user 34, the second user 36, or both, such as content type, content size, content source, content destination, supplemental content, digital content rights information, content modifications, the like, or any combination thereof. Examples of content type include audio data, video data, application data, and the like. Examples of content source or content destination include one or more home machine, one or more mobile device, cloud storage, peer-to-peer storage, one or more web site, and the like. Examples of supplemental content include annotations, advertisements, third party data, and the like. Examples of content modifications include transcoding, insertion of watermarks, insertion of advertisements, content stripping, and the like. The communications options information may include content sharing metadata associated with the first user 34, the second user 36, or both, such as time frame to deliver content, content quality options, connectivity requirements, distribution rights, the like, or any combination thereof. Examples of a time frame to deliver content include now, two hours from now, a specific time on a specific date, and the like. Examples of content quality options include color, black and white, screen resolution, audio format, audio resolution, and the like. Examples of connectivity requirements include third generation (3G) protocol, WIFI, Bluetooth™, proxy server, and the like. For example, a matchmaking request is made and accepted using the first and second communications devices 12, 14, which may both be iPhones™. Once communications are established, the first user 34 may wish to send a movie in a high definition format to the second user 36. Using content sharing metadata, the first user 34 may be able to view different source and destination devices that are available to send and receive the movie, different communications protocols that are available to send and receive the movie, the estimated transfer time associated with each set of protocols and formats, the estimated financial cost associated with each set of protocols and formats, and the estimated battery drain associated with each set of protocols and formats. Then, the first user 34 may choose to send the movie in a high definition format from the first user's 34 home computer to the second user's 36 home computer using a proxy server.

The matchmaking system 10 may execute a set of rules in association with the communications options information. For example, the first user 34 wishes to share some pictures stored in his first communications device 12 with the second user 36. The matchmaking system 10 determines that the first and second communications devices 12, 14 are in proximity to one another. Therefore, Bluetooth™ is the preferred transport method because the proximity would allow direct data transfer between the first and second communications devices 12, 14. However, based on the communications options information, the matchmaking system 10 determines that the first communications device 12 has Bluetooth™ capability, but the second communications device 14 does not. Therefore, Bluetooth™ cannot be used. However, based on the communications options information, the matchmaking system 10 determines that the first communications device 12 has WIFI capability and the second communications device 14 has 3G connectivity. Therefore, the matchmaking system 10 identifies a proxy server between the WIFI interface of the first communications device 12 and the 3G interface of the second communications device 14 as the transport method. Based on the communications options information, the matchmaking system 10 determines that the format of the second communications device 14 display is 240×240. Further, based on the communications options information, the matchmaking system 10 determines that the user wants to explicitly approve receipt of files larger than ten megabytes. The files are larger than ten megabytes, so the matchmaking system 10 sends a sharing request message to the second communications device 14. When the matchmaking system 10 receives permission, the matchmaking system 10 establishes transfer of the data from the first communications device 12 to the second communications device 14 in a 240×240 format. If the first communications device 12 is in direct communications with the second communications device 14, the first communications device 12 formats the data in the 240×240 format. If the first communications device 12 sends the data to the second communications device 14 through the matchmaking system 10, then either the first communications device 12 or the matchmaking system 10 formats the data in the 240×240 format.

The communications options information may be associated with content browsing. Once communications are established between the first and second communications devices 12, 14, the communications options information may be used in conjunction with data that may be obtained with browsing. Any or all of the above embodiments of communications options information may be associated with content browsing. Further, the communications options information associated with content browsing may include user preferences that may be specified by the first user 34, the second user 36, or both. The communications options information associated with content browsing may include content metadata that is related to browsing. For example, when the second user 36 is browsing certain content of the first user 34, content metadata may specify that that thumbnails of the content are to be provided and the thumbnails are to be sent in a specific order.

The matchmaking system 10 may use techniques to optimize performance according to one embodiment of the matchmaking system 10. For example, to reduce user identification times, the matchmaking system 10 may proactively prepare for queries from communications devices. The matchmaking system 10 may preemptively identify communications devices that are in proximity to one another, identify the associated matchmaking rules and options, and the communications options, and prepare for matchmaking requests. Similarly, the matchmaking system 10 may predict and prepare when communications devices are in proximity to one another based on calendar information, route information, or the like, and prepare for matchmaking requests. The matchmaking system 10 may preemptively prepare for matchmaking requests and allocate resources based on the quantity of communications devices that are in proximity to one another. As the quantity increases, the number of expected matchmaking requests increases.

Some or all of the matchmaking system 10 may include discrete circuitry, integrated circuitry, programmable circuitry, non-volatile circuitry, volatile circuitry, software executing instructions on computing hardware, firmware executing instructions on computing hardware, the like, or any combination thereof The computing hardware may include mainframes, micro-processors, micro-controllers, embedded controllers, digital signal processors (DSP)s, the like, or any combination thereof.

None of the embodiments of the present disclosure are intended to limit the scope of any other embodiment of the present disclosure. Any or all of any embodiment of the present disclosure may be combined with any or all of any other embodiment of the present disclosure to create new embodiments of the present disclosure.

Those skilled in the art will recognize improvements and modifications to the preferred embodiments of the present disclosure. All such improvements and modifications are considered within the scope of the concepts disclosed herein and the claims that follow.

What is claimed is:

1. A method of operating a matchmaking system comprising:
receiving a matchmaking request and recognition information from a first communications device associated with a first user regarding a second user, such that the recognition information comprises biometric data of the second user recorded by the first communications device;
attempting to identify the second user based on the recognition information; and
if the matchmaking request is successful based on successful identification of the second user:
identifying first data associated with the first user to be sent to a second communications device associated with the second user; and
sending the first data to the second communications device, wherein the first user wishes to establish communications with the second user using the matchmaking system.

2. The method of claim 1 wherein the biometric data comprises facial details of the second user.

3. The method of claim 2 wherein the biometric data comprises an optical image of a face of the second user.

4. The method of claim 2 wherein the biometric data comprises video images of a face of the second user.

5. The method of claim 2 wherein the attempting to identify the second user is further based on facial recognition.

6. The method of claim 1 wherein the biometric data comprises vocal characteristics of the second user.

7. The method of claim 6 wherein the biometric data comprises an audio recording of a voice of the second user.

8. The method of claim 6 wherein the attempting to identify the second user is further based on voice recognition.

9. The method of claim 1 wherein an identity of the second user is not recognized by the first user.

10. The method of claim 1 wherein the attempting to identify the second user is further based on executing a recognition algorithm using the recognition information.

11. The method of claim 1 wherein the recognition information further comprises location information pertaining to a current location of the second user.

12. The method of claim 11 wherein the recognition information further comprises locally obtained device information associated with the second communications device.

13. The method of claim 1 wherein the recognition information further comprises locally obtained device information associated with the second communications device.

14. The method of claim 13 wherein the locally obtained device information comprises a network device identification (ID) associated with the second communications device.

15. The method of claim 1 further comprising:
if identifying the second user is unsuccessful, sending a request for supplemental recognition information, which is associated with the second user, to the first communications device; and
receiving the supplemental recognition information from the first communications device.

16. The method of claim 15 wherein the supplemental recognition information comprises location information pertaining to a current location of the second user.

17. The method of claim 15 wherein the supplemental recognition information further comprises locally obtained device information associated with the second communications device.

18. The method of claim 1 further comprising if the identification of the second user is successful, determining if the matchmaking request is successful based on matchmaking rules and options, and the if the matchmaking request is successful based on the successful identification of the second user is further based on the matchmaking rules and options.

19. The method of claim 1 wherein the identifying the first data is based on communications options.

20. The method of claim 1 further comprising sending a matchmaking results notification message to the first communications device based on results of the matchmaking request.
